(19) United States
(12) Patent Application Publication
(10) Pub. No.: US 2024/0338844 A1
(43) Pub. Date: Oct. 10, 2024

(54) ACQUISITION METHOD FOR HUMAN BODY MEASUREMENT DATA, PROCESSING METHOD FOR HUMAN BODY MEASUREMENT DATA, AND DEVICE

(71) Applicant: Hangzhou Alibaba International Internet Industry Co., Ltd., Hangzhou (CN)

(72) Inventors: Yicun ZHUANG, Hangzhou (CN); Gaige WANG, Hangzhou (CN)

(21) Appl. No.: 18/750,451

(22) Filed: Jun. 21, 2024

Related U.S. Application Data
(63) Continuation of application No. PCT/CN2023/072482, filed on Jan. 17, 2023.

(30) Foreign Application Priority Data
Jan. 29, 2022 (CN) 202210112739.6

(51) Int. Cl. G06T 7/70; G06T 7/62

(52) U.S. Cl. CPC G06T 7/70; G06T 7/62; G06T 2207/20044; G06T 2207/30196

(57) ABSTRACT

A method for acquiring human body measurement data applicable to a terminal device, the terminal device including an imaging interface, the method comprises obtaining key point data of a target individual from a real-time image displayed on the imaging interface, determining whether to send a prompt message based on an analysis of the key point data of the target individual to prompt the target individual to adjust its standing position and/or posture, acquiring a full-body image of the target individual whose standing position and posture satisfy a preset criteria, and determining the human body measurement data of the target individual based on the key point data in the full-body image. The human body measurement data is used to indicate measurements of various body parts of the target individual.

### CROSS-REFERENCE TO RELATED APPLICATIONS

This application is a Continuation Application of International Patent Application No. PCT/CN2023/072482, filed on Jan. 17, 2023, which is based on and claims priority to and benefits of Chinese patent application No. 202210112739.6, filed with the China National Intellectual Property Administration on Jan. 29, 2022, and entitled “Methods and Apparatus for Acquiring and Processing Human Body Measurement Data.” The above-referenced applications are incorporated herein by reference in their entirety.

### TECHNICAL FIELD

Embodiments of this application relate to the field of computer vision technology, and in particular, to methods and apparatus for acquiring and processing human body measurement data.

### BACKGROUND

With the rapid development of information technology, the fashion industry is evolving towards digitalization and intelligentization. To meet the demands of online shoppers, e-commerce platforms have launched smart body measurement mini-programs that allow users to measure themselves and choose clothes online.

To enhance the accuracy of body measurements, the full-body photos taken by users need to meet specific posture guidelines. However, existing smart body measurement mini-programs are incapable of evaluate and adjust the user's posture during photo capture. Consequently, users must check their own photos for correct posture, which can compromise the accuracy of body measurement data calculated.

### SUMMARY

The embodiments of this application provide a method and apparatus for acquiring and processing human body measurement data, which, through the assessment and guidance of human posture in images, obtain high-quality human posture images, thereby enhancing the accuracy of human body measurement data.

A first aspect of the embodiments of this application provides a method for acquiring human body measurement data, applied in terminal devices, wherein an imaging interface of the terminal device displays a real-time image; the method includes:
obtaining key point data of a target individual in the real-time image;
determining whether to send a prompt message by analyzing the key point data of the target individual, wherein the prompt message is used to guide the target individual to adjust standing position and/or posture;
obtaining a full-body image of the target individual whose standing position and posture both meet the preset requirements, and determining the human body measurement data of the target individual based on the key point data of the target individual in the full-body image, wherein the human body measurement data is used to indicate the measurements of various parts of the target individual's body.

In an optional embodiment of the first aspect of this application, obtaining the key point data of the target individual in the real-time image includes:
using a lightweight human body key point detection model to obtain the key point data of the target individual from the real-time image, wherein the key point data includes the position data of all key points of the target individual.

In an optional embodiment of the first aspect of this application, determining whether to send a prompt message by analyzing the key point data of the target individual includes:
obtaining the number of key points based on the key point data of the target individual;
if the number of key points is less than a preset key point threshold, determining to send a first prompt message, which is used to indicate to the target individual to stand in a specified area of the imaging interface.

In an optional embodiment of the first aspect of this application, determining whether to send a prompt message by analyzing the key point data of the target individual includes:
determining a detection box corresponding to the target individual based on the key point data of the target individual:
obtaining the area ratio of the detection box to the real-time image:
if the area ratio is less than a preset area ratio threshold, determining to send a second prompt message, which is used to indicate to the target individual to move forward to the specified area of the imaging interface.

In an optional embodiment of the first aspect of this application, determining whether to send a prompt message by analyzing the key point data of the target individual includes:
determining posture data of the target individual based on the key point data of the target individual:
if the posture data is outside a preset value range corresponding to the posture data, determining to send a third prompt message, which is used to instruct the target individual to adjust standing posture.

In an optional embodiment of the first aspect of this application, the posture data includes at least one of the following:
arm opening degree, determined based on the position data of the upper limb key points of the target individual:
shoulder deviation, determined based on the position data of the left and right shoulder key points of the target individual:
trunk deviation, determined based on the position data of the limb key points and the height of the target individual:
leg bending degree, determined based on the position data of the lower limb key points and the height of the target individual:
arm verticality, determined based on the position data of the upper limb key points and the hip key points of the target individual.

In an optional embodiment of the first aspect of this application, the method further includes:
if it is determined to send a prompt message, displaying the prompt message on the imaging interface of the terminal device, or, broadcasting the prompt message through the speaker of the terminal device.

In an optional embodiment of the first aspect of this application, the full-body image includes both front and side full-body images of the target individual; determining the human body measurement data of the target individual based on the key point data of the target individual in the full-body image includes:
acquiring first key point data of the target individual in a front full-body image and second key point data of the target individual in a side full-body image;
determining the human body measurement data of the target individual based on the first key point data and the second key point data.

In an optional embodiment of the first aspect of this application, the method also includes:
storing the human body measurement data of the target individual in the terminal device.

In another optional embodiment of the first aspect of this application, the method further includes:
in response to a query operation on a graphical user interface of the terminal device. obtaining standard size data of a target item from a server:
wherein the graphical user interface includes the target item viewed by the target individual, and the query operation is for requesting to obtain a recommended size of the target item that fits the target individual:
based on the human body measurement data of the target individual and the standard size data, determining the recommended size and displaying the recommended size on the graphical user interface.

A second aspect of the embodiments of this application provides a processing method based on human body measurement data, applied in terminal devices, where an item interface of the terminal device displays a target item currently being browsed by a target individual; the method includes:
upon detecting a trigger action on a processing control of the item interface, obtaining standard size data of the target item from a server:
if the terminal device does not include human body measurement data of the target individual, controlling to enter an imaging interface, obtaining a full-body image of the target individual whose standing position and posture both meet preset requirements on the imaging interface, which includes prompt messages used to guide the target individual to adjust standing position and/or posture:
by acquiring the key point data of the target individual in a full-body image, determining the human body measurement data of the target individual, and based on the human body measurement data of the target individual and the standard size data, determining a recommended size.

In an optional embodiment of the second aspect of this application, if the processing control is a control for adding items to the shopping cart, the method also includes:
after determining the recommended size, generating add-to-cart information of the target individual based on the recommended size and an identifier of the target item.

In another optional embodiment of the second aspect of this application, if the processing control is a size inquiry control, the method also includes:
after determining the recommended size, controlling to enter a measurement display interface, and on the measurement display interface, displaying the human body measurement data of the target individual and the recommended size of the target item.

A third aspect of the embodiments of this application provides an apparatus for acquiring human body measurement data, comprising:
an acquisition module, for acquiring key point data of the target individual in a real-time image on an imaging interface of a terminal device:
a processing module, for determining whether to send a prompt message by analyzing the key point data of the target individual, where the prompt message is used to guide the target individual to adjust standing position and/or posture:
wherein the acquisition module is also used to obtain a full-body image of the target individual whose standing position and posture both meet the preset requirements:
wherein the processing module is also used to determine the human body measurement data of the target individual based on the key point data in the full-body image, where the human body measurement data is used to indicate the measurements of various parts of the target individual's body.

A fourth aspect of the embodiments of this application provides an apparatus for processing based on human body measurement data, comprising:
an acquisition module, for detecting a trigger action on a processing control of an item interface on a terminal device and obtaining standard size data of the target item from a server:
a processing module, for controlling entry into an imaging interface if the terminal device does not contain the human body measurement data of the target individual, wherein the acquisition module is also used to obtain a full-body image of the target individual whose standing position and posture both meet the preset requirements on the imaging interface, which includes prompt messages used to guide the target individual to adjust their standing position and/or posture:
wherein the processing module is also used to determine the human body measurement data of the target individual by acquiring the key point data in the full-body image, and based on the human body measurement data of the target individual as well as the standard size data, to determine the recommended size.

A fifth aspect of the embodiments of this application provides an electronic device, comprising: a memory, a processor, and a computer program: the computer program is stored in the memory and configured to be executed by the processor to implement the methods as described in any of the embodiments of the first aspect of this application, or the methods as described in any of the embodiments of the second aspect of this application.

A sixth aspect of the embodiments of this application provides a computer-readable storage medium, on which a computer program is stored. The computer program, when executed by a processor, implements the methods as described in any of the embodiments of the first aspect of this application, or the methods as described in any of the embodiments of the second aspect of this application.

A seventh aspect of the embodiments of this application provides a computer program product, comprising a computer program. When executed by a processor, the computer program implements the methods as described in any of the embodiments of the first aspect of this application, or the methods as described in any of the embodiments of the second aspect of this application.

The embodiments of this application provide a method for acquiring human body measurement data, which includes: a terminal device acquiring key point data of a target individual from the real-time image on the imaging interface, determining whether to send a prompt message based on the key point data of the target individual, wherein the prompt message is for guiding the target individual to adjust standing position and/or posture. After the target individual adjusts standing position and posture according to the prompt messages, the terminal device acquires a full-body image of the target individual whose standing position and posture meet preset requirements, and determines the human body measurement data of the target individual based on the key point data in the full-body image. This process involves posture recognition of the individual's key point data, determining whether shooting prompts are needed during the capture process to guide the target individual to collect full-body frontal and side images, thereby rapidly acquiring images that meet the posture requirements and improving the accuracy of human body measurement data.

The embodiments also provide a processing method based on human body measurement data, which involves obtaining standard size data of a target item based on the target individual's operations on an item interface. If the terminal device has not pre-stored the target individual's human body measurement data, it can control the terminal device to activate a camera, and based on the aforementioned method of acquiring human body measurement data, obtain the human body measurement data of the target individual. Subsequently, based on the human body measurement data of the target individual and the standard size data of the target item, a recommended size is displayed to the target individual or the item is directly added to their shopping cart, enhancing the user's experience.

### BRIEF DESCRIPTION OF THE DRAWINGS

FIG. 1 is a schematic diagram of the human body measurement data acquisition method provided by the embodiments of this application, Scene 1.

FIG. 2 is a schematic diagram of the human body measurement data acquisition method provided by the embodiments of this application, Scene 2.

FIG. 3 is a flowchart of the human body measurement data acquisition method provided by the embodiments of this application.

FIG. 4 is a schematic diagram of the imaging interface of the terminal device provided by the embodiments of this application, Illustration 1.

FIG. 5 is a schematic diagram of the imaging interface of the terminal device provided by the embodiments of this application, Illustration 2.

FIG. 6 is a schematic diagram of the imaging interface of the terminal device provided by the embodiments of this application, Illustration 3.

FIG. 7 is a schematic diagram of the imaging interface of the terminal device provided by the embodiments of this application, Illustration 4.

FIG. 8 is a schematic diagram of the full-body frontal image of the person provided by the embodiments of this application, Illustration 1.

FIG. 9 is a schematic diagram of the full-body frontal image of the person provided by the embodiments of this application, Illustration 2.

FIG. 10 is a schematic diagram of the posture data for the full-body frontal image of the person provided by the embodiments of this application.

FIG. 11 is a schematic diagram of the posture data for the full-body side image of the person provided by the embodiments of this application.

FIG. 12 is a flowchart of the processing method based on human body measurement data provided by the embodiments of this application.

FIG. 13 is a schematic diagram of the changes in the graphical user interface of the terminal device provided by the embodiments of this application.

FIG. 14 is a schematic diagram of the human body measurement data acquisition apparatus provided by the embodiments of this application, Illustration 1.

FIG. 15 is a schematic diagram of the human body measurement data acquisition apparatus provided by the embodiments of this application, Illustration 2.

FIG. 16 is a schematic diagram of the processing apparatus based on human body measurement data provided by the embodiments of this application.

FIG. 17 is a schematic diagram of the electronic device provided by the embodiments of this application.

### DETAIL DESCRIPTION OF THE EMBODIMENTS

To make the objectives, technical solutions, and advantages of the embodiments of this application clearer, the following will describe the technical solutions in the embodiments of this application clearly and completely in conjunction with the accompanying drawings of the embodiments. It is evident that the described embodiments are part of the embodiments of this application, rather than all of them. Based on the embodiments in this application, all other embodiments obtained by those of ordinary skill in the art without making creative efforts fall within the scope of protection of this application.

The use of terms such as “first.” “second.” and so on in the specification, claims, and the above drawings of the embodiments of this application is for distinguishing similar objects and not necessarily for describing a specific order or sequential order. It should be understood that such data can be exchanged under appropriate circumstances so that the embodiments of this application described here can be implemented in an order other than as illustrated or described herein.

It should be understood that the terms “comprising” and “having,” as well as any of their variants, are intended to cover non-exclusive inclusion. For instance, a process, method, system, product, or apparatus that includes a series of steps or units does not necessarily need to be limited to the steps or units listed explicitly: it can also include other steps or units not listed clearly or inherent to these processes, methods, products, or devices.

In the description of the embodiments of this application, the term “corresponding” can indicate a direct or indirect corresponding relationship between two elements, can also indicate a relationship of association between them, or can be indicative of relationships such as indicating and being indicated, configuring and being configured, among others.

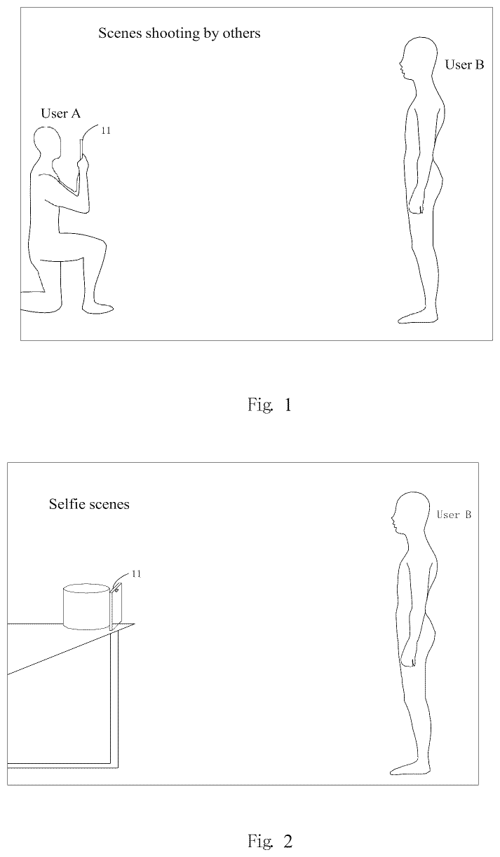

Before introducing the method for acquiring human body measurement data provided by this application, let's first briefly introduce the shooting scene of this acquisition method. FIG. 1 illustrates Scene 1 of the human body measurement data acquisition method

provided by the embodiments of this application. In the shooting scene shown in FIG. 1, User A is the photographer, and User B is the subject. User A and User B maintain a preset distance, for example, 2 meters. User A holds a terminal device 11 and captures the full-body frontal and side images of User B using the external camera of terminal device 11.

FIG. 2 illustrates Scene 2 of the human body measurement data acquisition method provided by the embodiments of this application. In the shooting scene shown in FIG. 2, User B acts both as the photographer and the subject. User B can use an adjustable stand to fix the terminal device 11 at a suitable height, or place the terminal device 11 on the surface of an object such as a table. The full-body frontal and side images of User B are captured using the front-facing camera of terminal device 11.

Based on either of the above shooting scenarios, terminal device 11 acquires the human body measurement data of User B by analyzing User B's full-body frontal and side images. The human body measurement data includes, but is not limited to, the three circumferences (circumferences of bust, waist, and hip), shoulder width, neck circumference, arm length, leg length, and more.

Currently, in some smart body measurement mini-programs, after completing the capture of a full-body frontal or side image, users are required to confirm their standing position and posture based on prompts to ensure the collected images are suitable for calculating human body measurement data. For example, users need to verify whether the full-body frontal image completely includes the person, whether the neck is clearly visible, and whether the legs are apart. Similarly, for the full-body side image, users need to confirm whether the entire person is included, whether the neck is clearly visible, and whether the front and back contours of the body are clearly visible.

As can be seen, existing smart body measurement mini-programs are unable to make real-time judgments and guidance on the user's shooting posture, requiring users to confirm each item after completing the shoot. For incorrectly captured content, users need to repeat the shooting multiple times, leading to a poor shooting experience. Currently, the accuracy of human body measurement data calculated from photos confirmed by users themselves is not high.

To address these issues, the embodiments of this application provide a method for acquiring human body measurement data. After acquiring real-time captured images, the method first utilizes a lightweight human body key point detection model preset in the terminal device to detect whether the image includes a person, the number of skeletal key points (hereinafter referred to as key points), and their locations, etc. Then, based on the detected key point data, the method uses a preset algorithm to identify whether the person's posture meets the standing posture requirements. According to the identification results, it determines whether to send voice or text prompts, thereby guiding the user to collect full-body frontal and side images. This approach aims to quickly acquire images that meet the posture requirements and improve the accuracy of human body measurement data.

It should be noted that the technical solutions provided by the embodiments of this application are primarily based on the shooting scenario illustrated in FIG. 2, which is a user-led shooting scenario. Users can adjust their standing position and posture in real-time in conjunction with text prompts on the imaging interface of the terminal device or voice prompts from the device's speaker, allowing the shooting process to be completed efficiently and quickly without the need to touch the screen.

The following sections will provide a detailed explanation of the technical solutions offered by the embodiments of this application through specific examples. It is important to clarify that the technical solutions provided by the embodiments of this application may encompass all or part of the contents described below. The specific embodiments mentioned below can be combined with each other, and for the sake of brevity, the same or similar concepts or processes may not be reiterated in certain embodiments.

FIG. 3 presents a flowchart of the human body measurement data acquisition method provided by the embodiments of this application. The method for acquiring human body measurement data, as provided in this embodiment, can be applied to terminal devices. As shown in FIG. 3, the method includes the following steps:

Step 101: Obtaining key point data of the target individual in the real-time image.

In this embodiment, the terminal device is pre-equipped with a lightweight human body key point detection model, which can be used to detect the positions of human body key points in images. Given the limited memory space and computational capabilities of terminal devices, it is advisable to choose a lightweight model structure. Through model pruning and model quantization compression, the model is pre-installed into the terminal device while ensuring the accuracy of model detection. Possible lightweight model structures include, but are not limited to, MoveNet, BlazePose. PoseNet, etc.

Specifically, the terminal device obtains the key point data of the target individual from the real-time image based on the lightweight human body key point detection model. The key point data includes the position data of all key points of the target individual, such as the coordinates of the limbs' key points in the real-time image.

Step 102: Determining whether to send prompt messages by analyzing the key point data of the target individual.

Specifically, the terminal device analyzes the key point data of the target individual to obtain at least one of the following: the number of key points of the target individual, the detection box corresponding to the target individual, and the posture data of the target individual. Based on at least one of these aspects-the number of key points, the detection box corresponding to the target individual, and various types of posture data of the target individual, the device determines whether to send prompt messages. These prompt messages are intended to guide the target individual to adjust their standing position and/or posture.

In an optional embodiment of this example, if the terminal device decides to send prompt messages, it displays the prompt messages on the imaging interface of the terminal device or broadcasts the prompt messages through the device's speaker.

In this embodiment, the terminal device analyzes the key point data of the target individual to identify whether a person is present in the real-time image, whether the entire body of the person is within the designated area of the real-time image (i.e., whether the person's standing position meets the requirements), and whether the person's posture meets the requirements. If any of these criteria are not met, the terminal device sends prompt messages. The purpose of sending prompt messages is to assist and guide the user in capturing images that meet the preset standing posture requirements for subsequent calculation of human body measurement data.

The following will provide a detailed explanation of the process of real-time image recognition and information prompting by the terminal device, combined with the accompanying drawings.

In an optional embodiment, the terminal device obtains the number of key points of the target individual based on their key point data. By comparing the number of key points of the target individual with a preset key point threshold, it determines whether to send the first prompt message.

The preset key point threshold refers to the number of key points necessary to recognize the full body of a person. Depending on the algorithm settings, the preset key point threshold may vary: similarly, based on the type of image, the preset key point threshold may differ, meaning that the threshold for a person's frontal image and side image are not the same.

Specifically, if the number of key points of the target individual is less than the preset key point threshold, it is determined to send the first prompt message. The first prompt message is intended to indicate to the target individual to stand in the designated area of the terminal device's imaging interface, essentially guiding the target individual to adjust their standing position.

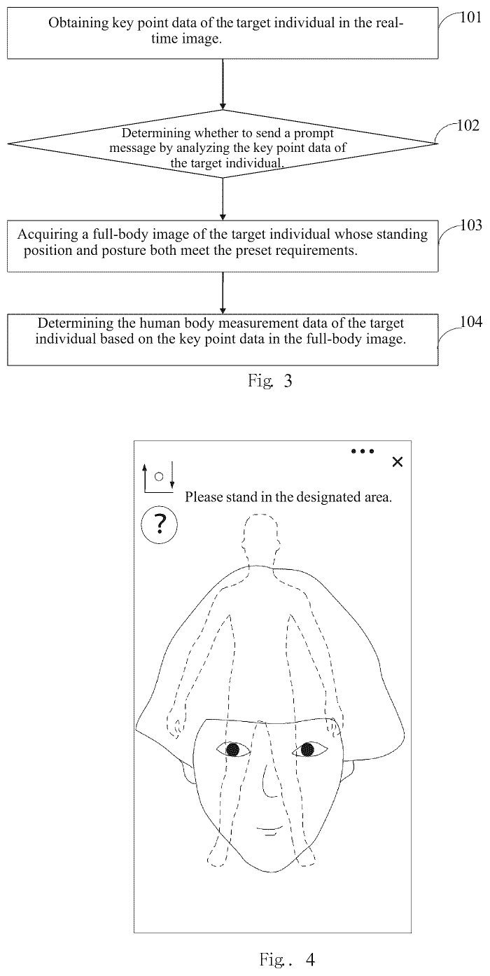

FIG. 4 is a schematic illustration. Illustration 1, of the imaging interface of the terminal device provided by the embodiments of this application. As shown in FIG. 4, the real-time image on the imaging interface of the terminal device only includes facial key points of the person, such as the eyes, ears, and nose. Based on the key point data of the person in this real-time image, if the number of person's key points is determined to be 5, which is less than the preset key point threshold (indicating an insufficient number of the person's key points), the terminal device can provide text prompts on the imaging interface, as illustrated in FIG. 4 with the prompt “Please stand in the designated area.” Additionally, the terminal device can provide voice prompts through the speaker or offer both text and voice prompts simultaneously.

In an optional embodiment, the terminal device determines the detection box corresponding to the target individual based on the key point data of the target individual. It then calculates the area ratio of the detection box to the real-time image and compares this area ratio with a preset area ratio threshold to determine whether to send the second prompt message.

Specifically, if the area ratio of the detection box to the real-time image is less than the preset area ratio threshold, it is determined to send the second prompt message. The second prompt message is intended to guide the target individual to move forward to the designated area of the imaging interface, effectively instructing the target individual to adjust their standing position.

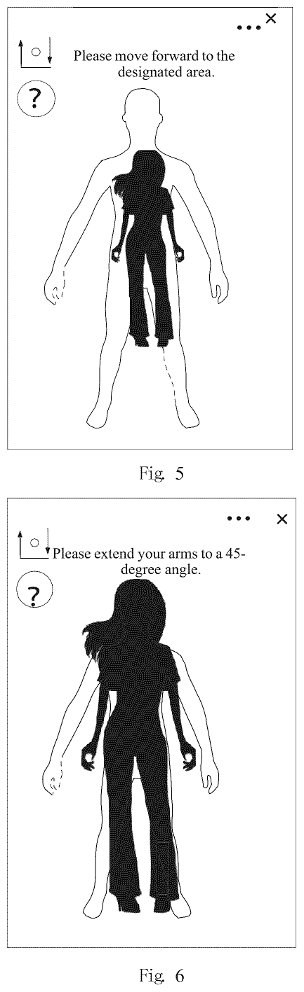

FIG. 5 is a schematic illustration, Illustration 2, of the imaging interface of the terminal device provided by the embodiments of this application. As shown in FIG. 5, the real-time image on the imaging interface of the terminal device includes the person's key points meeting the preset key point quantity. Based on the person's key points, the detection box in the real-time image is determined, and the area ratio of the person's detection box to the real-time image is calculated. Since this area ratio is less than the preset area ratio threshold, indicating that the distance between the person and the terminal device is greater than the preset distance value, the terminal device can provide text prompts on the imaging interface, as illustrated in FIG. 5 with the prompt “Please move forward to the designated area.” Additionally, the terminal device can offer voice prompts through the speaker or provide both text and voice prompts simultaneously.

In another optional embodiment, the terminal device determines the posture data of the target individual based on their key point data. It then assesses whether the posture data of the target individual falls within the preset value range corresponding to the posture data, thereby determining whether to send the third prompt message.

Specifically, if the posture data of the target individual falls outside the preset value range corresponding to the posture data, it is determined to send the third prompt message. The third prompt message is intended to guide the target individual to adjust their standing posture.

Optionally, the posture data of the target individual may include upper limb posture data. lower limb posture data, head posture data, shoulder posture data, and trunk posture data, among others.

It should be noted that the posture data requirements for each part of the human body (i.e., the preset value range corresponding to each part's posture data) can be set based on actual needs. and this embodiment does not impose specific limitations.

For example, if the upper limb posture data of the target individual falls outside the preset value range for upper limb posture data, it is determined to send the third prompt message.

Similarly, if the lower limb posture data of the target individual falls outside the preset value range for lower limb posture data, it is determined to send the third prompt message.

If the head posture data of the target individual falls outside the preset value range for head posture data, it is determined to send the third prompt message.

If the shoulder posture data of the target individual falls outside the preset value range for shoulder posture data, it is determined to send the third prompt message.

Lastly, if the trunk posture data of the target individual falls outside the preset value range for trunk posture data, it is determined to send the third prompt message.

Optionally, the posture data of the target individual includes both frontal posture data and side posture data. Both frontal and side posture data encompass the various types of posture data mentioned previously.

FIG. 6 is a schematic illustration, Illustration 3, of the imaging interface of the terminal device provided by the embodiments of this application. As shown in FIG. 6, the real-time image on the imaging interface of the terminal device contains the preset number of person key points, and the area ratio of the person's detection box to the real-time image meets the preset area ratio threshold, but the person's arms are not extended when standing frontally. Based on the key point data of the person's upper limbs, the terminal device obtains the upper limb posture data. determining that the upper limb posture data falls outside the preset value range for upper limb posture data. The terminal device can then provide text prompts on the imaging interface, as illustrated in FIG. 6 with the prompt “Please extend your arms to a 45-degree angle.” Additionally, the terminal device can offer voice prompts through the speaker or provide both text and voice prompts simultaneously.

It should be noted that the example shown in FIG. 6 is just one instance of posture adjustment. Other actions that do not meet the preset posture requirements, such as bending of the legs, uneven shoulders, etc., are within the scope of posture adjustment covered by the embodiments of this application.

Step 103: Acquiring a full-body image of the target individual whose standing position and posture both meet the preset requirements.

In this embodiment, the full-body image includes the target individual's frontal full-body image and side full-body image. Acquiring a full-body image of the target individual whose standing position and posture both meet the preset requirements involves obtaining a frontal full-body image of the target individual whose standing position and posture meet the preset frontal posture requirements, as well as a side full-body image of the target individual whose standing position and posture meet the preset side posture requirements.

By way of illustration, preset frontal posture requirements include standing vertically frontally, feet shoulder-width apart, and arms raised at a 45-degree angle. Preset side posture requirements include standing vertically in a side profile, with arms hanging vertically by the sides.

Step 104: Determining the human body measurement data of the target individual based on the key point data in the full-body image. The human body measurement data is used to indicate the measurements of various parts of the target individual's body.

After obtaining both the frontal and side full-body images of the target individual, whose standing position and posture meet the preset requirements, the terminal device, utilizing a lightweight human body key point detection model, acquires the first key point data from the frontal full-body image and the second key point data from the side full-body image. Based on both the first and second key point data, it determines the human body measurement data of the target individual. The human body measurement data includes measurements such as the circumferences of bust, waist and hip, shoulder width, neck circumference, arm length, leg length, etc.

Optionally, in some embodiments, after determining the human body measurement data of the target individual, the terminal device stores the person's human body measurement data on the device.

In this embodiment, by collecting full-body frontal and side images that meet the standing posture requirements on the terminal side, and obtaining key point data of the human body from the images, the terminal device calculates the measurements of various body parts based on the key point data. The measurement data is not uploaded to a server but saved on the terminal side, ensuring the security of user privacy data.

The method for acquiring human body measurement data demonstrated in the embodiments of this application involves the terminal device acquiring key point data of the target individual from the real-time image on the imaging interface. Based on the key point data of the target individual, it determines whether to send prompt messages, which are intended to guide the target individual to adjust their standing position and/or posture. After the target individual adjusts their standing position and posture according to the prompt messages, the terminal device acquires a full-body image of the target individual, whose standing position and posture meet the preset requirements. It then determines the human body measurement data of the target individual based on the key point data in the full-body image. This process involves posture recognition based on the person's key point data, using posture recognition to decide whether to provide shooting prompts during the capture process, thereby guiding the target individual to collect full-body frontal and side images. This enables the rapid acquisition of images that meet standing posture requirements, thereby enhancing the accuracy of human body measurement data.

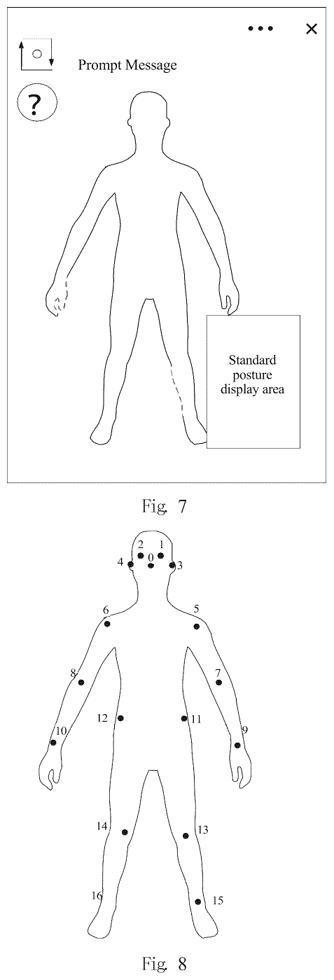

FIG. 7 is a schematic illustration. Illustration 4, of the imaging interface of the terminal device provided by the embodiments of this application. Building on the imaging interfaces shown in FIG. 4, 5, or 6, FIG. 7 illustrates that a standard posture display area can be added to the lower right corner of the imaging interface. This display area is intended to show the standard posture for the current shooting scenario, assisting users in adjusting their posture.

Based on the above embodiments, optionally, the number of key points for the target individual includes both the number of key points on the target individual's face and the number of key points on the target individual's body.

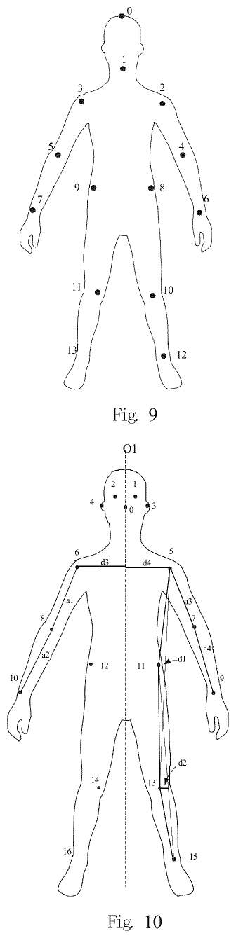

FIG. 8 is a key point schematic illustration of a full-body frontal image of a person provided by the embodiments of this application. As shown in FIG. 8, facial key points include the nose (0), left eye (1), right eye (2), left ear (3), and right ear (4). Body key points include the left shoulder (5), right shoulder (6), left elbow (7), right elbow (8), left wrist (9), right wrist (10), left hip (11), right hip (12), left knee (13), right knee (14), left ankle (15), and right ankle (16). The total number of key points for a full-body frontal image of a person is 17.

Optionally, the preset key point thresholds include both facial key point thresholds and body key point thresholds.

By way of illustration, for the full-body frontal image of a person, the threshold for facial key points is set at 1, and the threshold for body key points is set at 12, making the total preset key point threshold 13. In one scenario, if the number of facial key points for the target individual is 0, or if the number of body key points is less than 12, this indicates that the target individual has not fully entered the designated area. Consequently, the terminal device sends the first prompt message, advising the target individual to stand in the designated area. In another scenario, if the total number of key points for the target individual is less than 13, this also indicates that the target individual has not fully entered the designated area, leading the terminal device to send the first prompt message.

For example, for the full-body side image of a person, the facial key point threshold is 1, and the body key point threshold is 6, setting the total preset key point threshold at 7. In one scenario, if the number of facial key points for the target individual is 0, or if the number of body key points is less than 6, it may suggest that the target individual has not fully entered the designated area. Hence, the terminal device sends the first prompt message, advising the target individual to stand in the designated area. In another scenario, if the total number of key points for the target individual is less than 7, this indicates that the target individual has not fully entered the designated area, prompting the terminal device to send the first prompt message.

The human body key point detection model may not perform fine-grained detection of a person's face but instead detect the person's head, such as only detecting the top of the head and the chin.

Optionally, the number of key points for the target individual includes the number of key points on the target individual's head, as well as the number of key points on the target individual's body.

FIG. 9 provides a key point schematic of a full-body frontal image of a person in the embodiments of this application as shown in Illustration 2. As shown in FIG. 9, the head key points include the top of the head (0) and the chin (1). The body key points include the left shoulder (2), right shoulder (3), left elbow (4), right elbow (5), left wrist (6), right wrist (7), left hip (8), right hip (9), left knee (10), right knee (11), left ankle (12), and right ankle (13). Therefore, the total number of key points for a full-body frontal image of a person is 14.

Optionally, the preset key point thresholds include thresholds for head key points as well as body key points.

As an example, for a full-body frontal image of a person, the head key point threshold is set at 1, and the body key point threshold is set at 12, making the total preset key point threshold 13. Details for this scenario can refer to the earlier examples, which will not be expanded upon further here.

By way of illustration, for a full-body side image of a person, the head key point threshold is 1, and the body key point threshold is 6, setting the total preset key point threshold at 7. Details for this scenario can also refer to the earlier examples and will not be elaborated further here.

Building upon the aforementioned examples, optionally, the posture data for the target individual may include at least one of the following: the degree of openness of the upper limbs, shoulder offset, trunk offset, the bending degree of the lower limbs, and the verticality of the upper limbs.

Wherein, the degree of openness of the upper limbs is determined based on the position data of the target individual's upper limb key points; shoulder offset is determined based on the position data of the target individual's left and right shoulder key points; trunk offset is determined based on the position data of the target individual's limb key points and height. The bending degree of the lower limbs is determined based on the position data of the target individual's lower limb key points and height; the verticality of the upper limbs is determined based on the position data of the target individual's upper limb key points and hip key points.

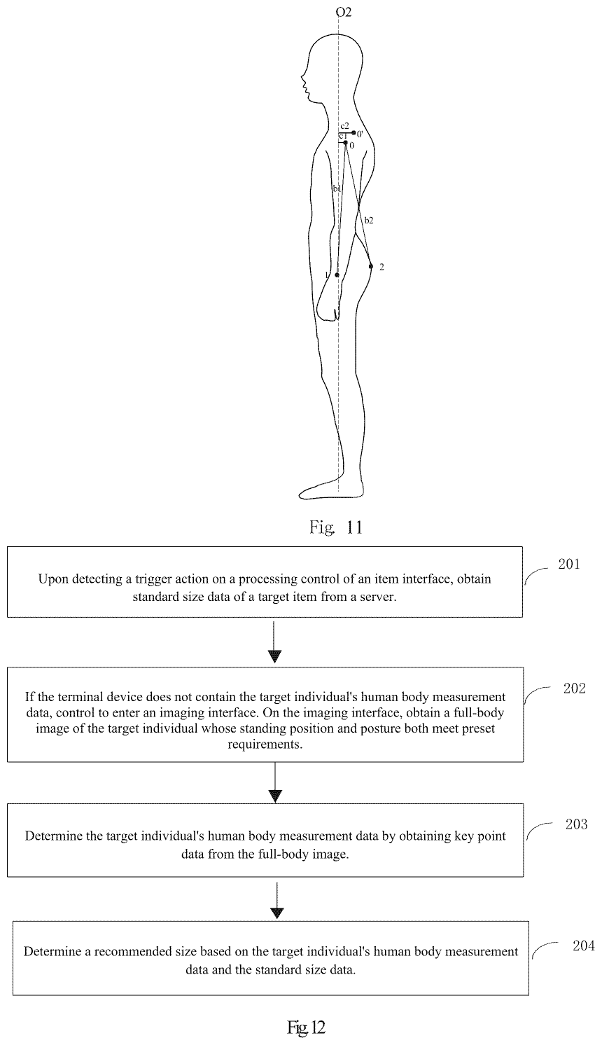

The following sections will detail how each type of posture data is determined, in conjunction with FIGS. 10 and 11.

FIG. 10 is a schematic illustration of the posture data for a full-body frontal image of a person, as provided by the embodiments of this application.

By way of illustration, the degree of openness of the upper limbs is determined based on the position data of the upper limb key points 5-10 as shown in FIG. 10.

Specifically, the average angle between the four lines (a1, a2, a3, a4) shown in FIG. 10 and the frontal midline axis O1 of the person is obtained. If the average value is outside the range of 40 to 50 degrees, it indicates that the person's arms are not opened to 45 degrees, prompting the terminal device to send the corresponding posture adjustment prompt message. The frontal midline axis of a person can be determined by synthesizing multiple pairs of symmetrical points on both sides of the midline.

By way of illustration, shoulder offset is determined based on the position data of the left and right shoulder key points 5 and 6 as shown in FIG. 10. Specifically, the difference in distance of each shoulder from the frontal midline axis O1 of the person is obtained, that is, the distance difference determined by d3 and d4 as shown in FIG. 10. This distance difference can characterize the degree of shoulder offset. If the absolute value of the distance difference between d3 and d4 exceeds a preset distance value (for example, 10 cm), and both shoulders are located on opposite sides of the frontal midline axis O1, it indicates that the person is not standing frontally and has an angular offset, prompting the terminal device to send the corresponding posture adjustment prompt message.

By way of illustration, trunk offset is determined based on the position data of the limb key points , 11, and 13 shown in FIG. 10, as well as the person's height. Specifically, the distance d1 from the left hip 11 to the line connecting the left shoulder 5 and the left knee 13 is obtained. The ratio of d1 to the person's height is used as a measure of trunk offset, characterizing the bending degree of the person's upper body. If the ratio of d1 to the person's height exceeds a preset ratio (for example, 7%), it indicates that the person's upper body is not upright, prompting the terminal device to send the corresponding posture adjustment prompt message. Here, the person's height is a piece of basic data previously input by the user, which also includes the person's weight.

By way of illustration, the bending degree of the lower limbs is determined based on the position data of the lower limb key points 11, 13, and 15 shown in FIG. 10, as well as the person's height. Specifically, the distance d2 from the left knee 13 to the line connecting the left hip 11 and the left ankle 15 is obtained. The ratio of d2 to the person's height is used as a measure of the bending degree of the lower limbs. If the ratio of d2 to the person's height exceeds a preset ratio (for example, 7%), it indicates that the person's lower body is not upright, prompting the terminal device to send the corresponding posture adjustment prompt message.

FIG. 11 is a schematic illustration of the posture data for a full-body side image of a person, as provided by the embodiments of this application.

By way of illustration, the verticality of the upper limbs is determined based on the position data of the upper limb key points 0 and 1, and the hip key point 2 shown in FIG. 11. Specifically, the angle between the line b1 connecting the left wrist 1 and the left shoulder 0 and the line b2 connecting the left shoulder 0 and the hip 2 is obtained. This angle value can characterize the verticality of the person's left arm. If the angle value exceeds a preset angle value (for example, 30°), it indicates that the person's left arm is not hanging vertically close to the body, prompting the terminal device to send the corresponding posture adjustment prompt message.

By way of illustration, shoulder offset is determined based on the position data of the left and right shoulder key points 0 and 0′ shown in FIG. 11. If there is an angular offset in the shoulders while the person stands sideways, the left shoulder 0 and right shoulder 0′ will be detected in the full-body side image. It is understood that in a standard side standing posture, the left and right shoulder points would overlap. If the left and right shoulders are on one side of the side midline axis O2 of the person, and the average distance value ((c1+c2)/2) of the left and right shoulders from the side midline axis O2 exceeds a preset distance value (for example, 10 cm), it indicates that the person is not standing correctly in profile, with an angular offset, prompting the terminal device to send the corresponding posture adjustment prompt message. The side midline axis of a person can be determined by the line connecting the top of the head and the bottom of the feet.

It should be noted that the types of posture data mentioned above serve merely as examples. Other kinds of posture data can be designed based on the same or similar principles, and this embodiment does not illustrate them all.

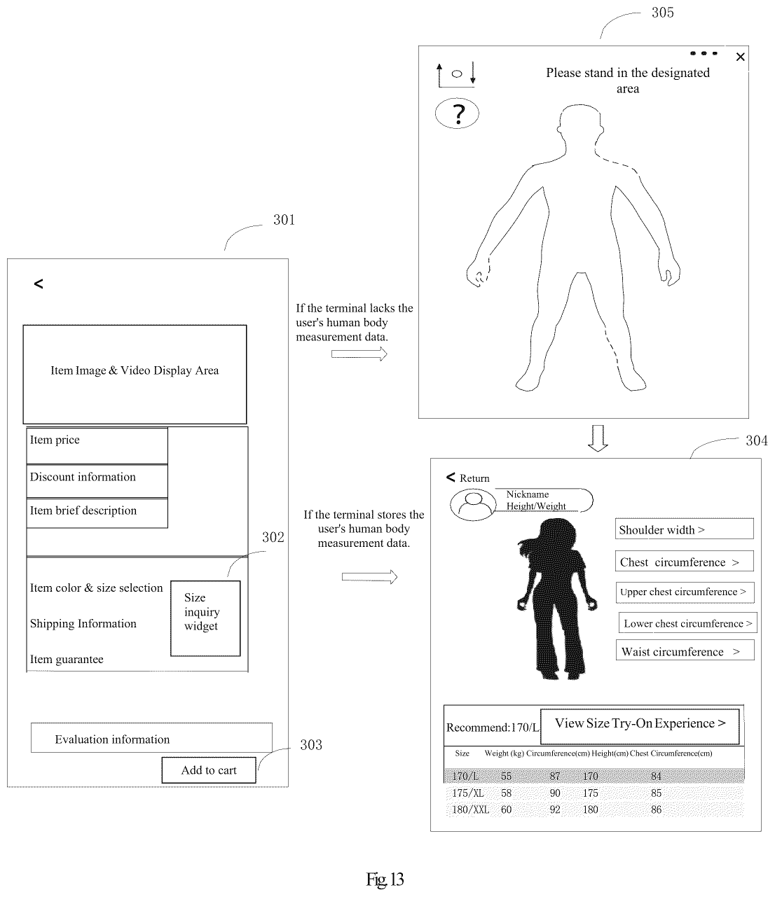

FIG. 12 is a flowchart of the processing method based on human body measurement data, as provided by the embodiments of this application. The method, applied to a terminal device, operates within an item interface that displays the target item currently being browsed by the target individual. By way of illustration, the item interface could be a product detail page within an e-commerce application app. As shown in FIG. 12, the method includes the following steps:

Step 201: Upon detecting a trigger action on the processing control of the item interface, obtain the standard size data of the target item from a server.

Optionally, the processing control could be a control for adding items to the cart or a size query control.

In this embodiment, the target item could be clothing items such as tops, pants, hats, etc. This embodiment does not specify particular items: any item related to human body measurement data falls within the scope of protection of this embodiment.

Step 202: If the terminal device does not contain the target individual's human body measurement data, control to enter the imaging interface. On the imaging interface, obtain a full-body image of the target individual whose standing position and posture both meet the preset requirements.

Step 203: Determine the target individual's human body measurement data by obtaining key point data from the full-body image.

Step 204: Determine the recommended size based on the target individual's human body measurement data and the standard size data.

After the terminal device enters the imaging interface, it displays a real-time image on the imaging interface and acquires the key point data of the target individual from the real-time image. By analyzing the key point data of the target individual, it determines whether to send prompt messages, which are used to guide the target individual to adjust their standing position and/or posture. The method of acquiring the key point data of the target individual is the same as described in the previous examples and will not be reiterated here.

By way of illustration, if the target individual's standing position and/or posture do not meet the preset requirements, prompt messages are sent on the imaging interface.

By way of illustration, if the target individual's standing position and/or posture do not meet the preset requirements, prompt messages are broadcast through the terminal device's speaker.

By way of illustration, if the target individual's standing position and/or posture do not meet the preset requirements, prompt messages are sent on the imaging interface, and simultaneously, prompt messages are broadcast through the terminal device's speaker.

After the target individual adjusts their standing position and posture in response to the prompt messages and/or voice prompts on the imaging interface, the terminal device captures a full-body image of the target individual, whose standing position and posture both meet the preset requirements. Utilizing a lightweight human body key point detection model, the device then acquires key point data from the full-body image. Based on the key point data in the full-body image, it determines the target individual's human body measurement data, which is used to indicate the measurements of various parts of the target individual's body. The full-body image includes both the frontal and side images of the body. The process mentioned above can refer to the previous examples and will not be reiterated here.

Optionally, in some embodiments, if the terminal device does not contain the target individual's human body measurement data, it controls entry into an information acquisition interface before accessing the imaging interface. After the target individual enters basic data, including height and weight, on the information acquisition interface, they proceed to the imaging interface.

Optionally, in some embodiments, if the terminal device does not contain the target individual's human body measurement data, the device controls entry into the imaging interface. After obtaining a full-body image of the target individual that meets the requirements, it controls entry into the information acquisition interface, where the target individual enters the aforementioned basic data. Subsequently, the terminal device controls entry into a body measurement display interface.

Optionally, in some embodiments, if the terminal device includes the target individual's human body measurement data, it directly determines the recommended size of the target item that fits the target individual based on the person's human body measurement data and the standard size data of the target item. In this embodiment, the target individual's human body measurement data is the historical human body measurement data saved in the terminal device after the person has previously measured themselves. The device can directly retrieve the target individual's human body measurement data based on the current operation of the target individual. After determining the recommended size, it displays the recommended size or adds the item to the cart.

By way of illustration, if the processing control is for adding items to the cart, the terminal device, upon determining the recommended size, generates add-to-cart information for the target individual based on the recommended size and the identifier of the target item.

By way of illustration, if the processing control is a size query control, the terminal device, after determining the recommended size, controls entry into the body measurement display interface. On this interface, it displays the target individual's human body measurement data and the recommended size for the target item.

FIG. 13 is a schematic illustration of changes in the graphical user interface of the terminal device as provided by the embodiments of this application. As shown in FIG. 13, the graphical user interface 301 includes information such as pictures, videos, prices, and feature descriptions of the target item. It also has controls 302 and 303, where control 302 is used to trigger size inquiries, and control 303 is used to add the target item to the cart.

As an example, when a user activates control 302, if the terminal device already has the user's body measurement data stored, the interface transitions to the body measurement display interface 304. This interface displays the recommended size of the target item that fits the user.

As another example, when a user activates control 302, if the terminal device does not have the user's body measurement data, the interface transitions to the imaging interface 305. By obtaining full-body images from the front and side that meet the standing posture requirements on the imaging interface 305, the user's body measurement data is determined, and then the interface transitions to the body measurement display interface 304.

Optionally, if the terminal device does not have the user's basic data pre-stored, such as height and weight, it can also control the interface to jump to an information acquisition interface (not illustrated) before or after taking the frontal and side full-body images. This interface is used to acquire the user's basic data.

By way of illustration, when a user triggers control 303, if the terminal device has the user's body measurement data pre-stored, it directly adds the target item of the recommended size to the cart for the user after determining the recommended size.

By way of illustration, when a user triggers control 303, if the terminal device does not have the user's body measurement data, the interface jumps to the imaging interface 305. By acquiring full-body images that meet the standing posture requirements from the imaging interface 305, the user's body measurement data is determined, and subsequently, the recommended size is determined. When the user navigates back to the item interface, the target item of the recommended size is directly added to the cart for the user.

The processing method based on human body measurement data provided by this embodiment can meet users' needs to quickly obtain recommended sizes or directly add items to their cart while browsing items. If the terminal device does not have a record of the user's body measurement data, it can quickly initiate capturing on the item browsing interface. Through data extraction and analysis by the lightweight human body key point detection model on the terminal side, it rapidly acquires the user's body measurement data, facilitating the recommendation or addition of item sizes.

The above text described the method for acquiring human body measurement data and the processing method based on human body measurement data provided by the embodiments of this application. The following will describe the device for acquiring human body measurement data and the processing device based on human body measurement data provided by the embodiments of this application.

This embodiment of the application can divide the functionality of the device for acquiring human body measurement data and the processing device based on human body measurement data into functional modules, according to the method examples described above. For instance, each function can be allocated to separate functional modules, or two or more functions can be integrated into a single processing module. The integrated modules can be implemented either in the form of hardware or as software functional modules. It should be noted that the division of modules in this embodiment is illustrative, representing only a logical division of functions, and the actual implementation may have different divisions. The following explanation is provided using the example of dividing each function into separate functional modules.

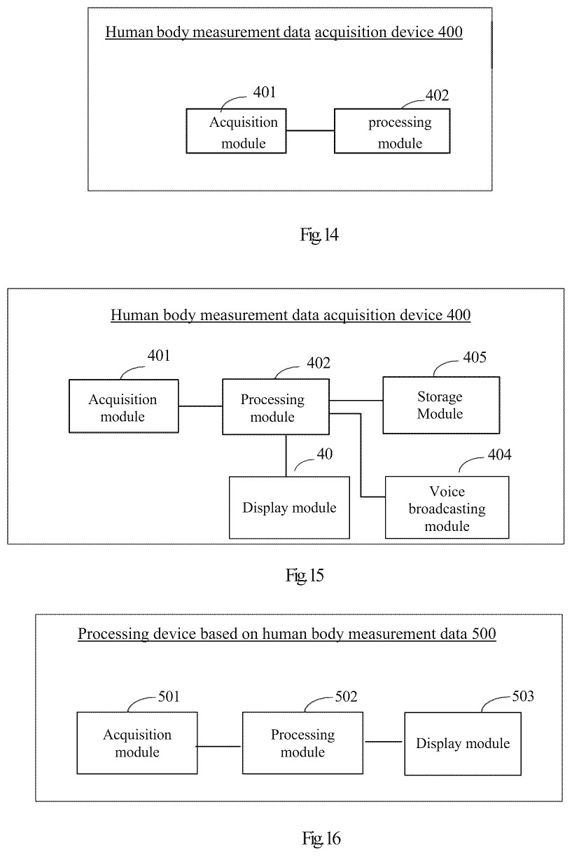

FIG. 14 is a schematic structure diagram of the device for acquiring human body measurement data provided by this embodiment. As depicted in FIG. 14, the human body measurement data acquisition device, designated as 400, includes: an acquisition module 401 and a processing module 402.

Acquisition module 401 is tasked with acquiring key point data of the target individual from the real-time image displayed on the terminal device's imaging interface.

Processing module 402 is responsible for analyzing the key point data of the target individual to determine whether to issue prompt messages. These prompt messages aim to guide the target individual in adjusting their standing position and/or posture.

The acquisition module 401 is also used for acquiring a full-body image of the target individual whose standing position and posture meet the preset requirements.

The processing module 402 further utilizes the key point data from the full-body image to determine the human body measurement data of the target individual. This human body measurement data is employed to indicate the measurements of various parts of the target individual's body.

In an optional embodiment of this example, the acquisition module 401 is used for:
acquiring key point data of the target individual from the real-time image based on a lightweight human body key point detection model. The key point data includes the position data of all key points of the target individual.

In an optional embodiment of the first aspect of this application, the processing module 402 is used for:
obtaining the number of key points based on the key point data of the target individual:

If the number of key points is less than a preset key point threshold, determining to send the first prompt message. This first prompt message is used to indicate to the target individual to stand in the designated area of the imaging interface.

In an optional embodiment of this example, the processing module 402 is used for:
determining the detection box corresponding to the target individual based on the key point data of the target individual:
obtaining the area ratio of the detection box to the real-time image:

If the area ratio is less than a preset area ratio threshold, deciding to send the second prompt message. This second prompt message is used to guide the target individual to move forward to the designated area of the imaging interface.

In another optional embodiment of this example, the processing module 402 is used for:
determining the posture data of the target individual based on the key point data of the target individual;
if the posture data falls outside the preset value range corresponding to the posture data. deciding to send the third prompt message. This third prompt message is used to guide the target individual to adjust their standing posture.

In an optional embodiment of this example, the posture data includes at least one of the following:
the degree of openness of the upper limbs, which is determined based on the position data of the upper limb key points of the target individual:
shoulder offset, which is determined based on the position data of the left and right shoulder key points of the target individual:
trunk offset, which is determined based on the position data of the limb key points and the height of the target individual:
the bending degree of the lower limbs, which is determined based on the position data of the lower limb key points and the height of the target individual:
the verticality of the upper limbs, which is determined based on the position data of the upper limb key points and the hip key points of the target individual.

FIG. 15 is a schematic structure diagram of the device for acquiring human body measurement data provided by this embodiment, referred to as Diagram 2. Building upon the device shown in FIG. 14, as illustrated in FIG. 15, the device for acquiring human body measurement data, designated as 400, further includes: a display module 403, a voice broadcasting module 404, and a storage module 405.

In an optional embodiment of this example, if the processing module 402 decides to send the prompt messages, the display module 403 is used to show the prompt messages on the imaging interface of the terminal device, or alternatively, the voice broadcasting module 404 is used to broadcast the prompt messages through the speaker of the terminal device.

In an optional embodiment of this example, the full-body image includes both the frontal full-body image and the side full-body image of the target individual. The acquisition module 401 is responsible for acquiring the first key point data from the frontal full-body image and the second key point data from the side full-body image of the target individual.

The processing module 402 utilizes both the first and second key point data to determine the human body measurement data of the target individual.

In an optional embodiment of this example, the storage module 405 stores the human body measurement data of the target individual on the terminal device.

The device for acquiring human body measurement data provided by this embodiment can execute the technical scheme of the method example shown in FIG. 3. Its underlying principles and technological effects are similar and are not reiterated here.

FIG. 16 is a schematic structure diagram of the processing device based on human body measurement data provided by this embodiment. As shown in FIG. 16, the processing device based on human body measurement data, designated as 500, includes: an acquisition module 501, a processing module 502, and a display module 503.

Module 501 is configured to retrieve standard size data of the target item from the server upon detecting a triggering operation of processing controls on the interface for items related to terminal equipment.

Module 502 is configured to, if the terminal device does not include body measurement data of the target individual, control access to the imaging interface. Module 501 is also used to obtain a full-body image of the target individual with standing position and posture meeting predetermined criteria on said imaging interface, which includes prompt information for guiding the target individual to adjust standing position and/or posture.

Module 502 is further configured to determine the body measurement data of the target individual by acquiring key point data from the full-body image of the target individual and, based on the body measurement data of the target individual and the standard size data, ascertain the recommended size.

In an optional embodiment of this implementation, if the processing control is for adding items to the cart, module 502 is additionally responsible for generating the target individual's shopping cart information based on the recommended size and the identification of the target item, after determining the recommended size.

In an optional embodiment of this implementation, if the processing control is for size inquiry, module 502 further controls access to the measurement display interface after determining the recommended size.

Display module 503 is used to present the body measurement data of the target individual and the recommended size of the target item on the measurement display interface.

The processing device provided in this embodiment based on body measurement data can execute the technical solution of the exemplary method illustrated in FIG. 12. Its implementation principle and technical effects are similar, and therefore, further elaboration is omitted here.

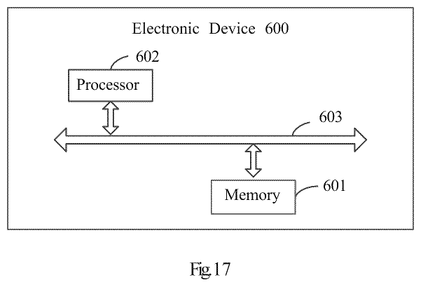

FIG. 17 depicts the hardware architecture of the electronic device provided in this application embodiment. As shown in FIG. 17, the electronic device 600 comprises a memory 601, a processor 602, and computer programs. Specifically, the computer programs are stored in the memory 601 and configured to be executed by the processor 602 to implement the technical solutions of any of the exemplary method embodiments described above. The implementation principles and technical effects of these solutions are similar, and therefore, further elaboration is omitted here.

Optionally, the memory 601 can be either independent or integrated with the processor 602. When the memory 601 is a separate device from the processor 602, the electronic device 600 further includes a bus 603 for connecting the memory 601 and the processor 602.

This application embodiment also provides a non-transitory computer-readable storage medium storing computer programs, which, when executed by processor 602, implement the technical solutions of any of the aforementioned method embodiments.

Furthermore, this application embodiment provides a computer program product comprising computer programs that, when executed by a processor, realize the technical solutions of any of the aforementioned method embodiments.

Additionally, this application embodiment further provides a chip comprising a processing module and a communication interface. The processing module is capable of executing the technical solutions of any of the aforementioned method embodiments.

Moreover, the chip further includes a storage module (e.g., memory), which stores instructions. The processing module executes the instructions stored in the storage module, and the execution of the instructions stored in the storage module causes the processing module to implement the technical solutions of any of the aforementioned method embodiments.

It should be understood that the above-mentioned processor can be a Central Processing Unit (CPU), or it can be other general-purpose processors, Digital Signal Processors (DSPs), Application Specific Integrated Circuits (ASICs), etc. General-purpose processors can be microprocessors or any conventional processors. The steps of the method disclosed in the invention can be directly embodied as hardware processor execution or executed in combination with hardware and software modules in the processor.

The memory may contain high-speed RAM memory and may also include non-volatile storage NVM, such as at least one disk storage, which may be a USB flash drive, a mobile hard drive, read-only memory, disk, or optical disc.

The bus may be an Industry Standard Architecture (ISA) bus, a Peripheral Component Interconnect (PCI) bus, or an Extended Industry Standard Architecture (EISA) bus, etc. The bus may be divided into address buses, data buses, control buses, etc. For ease of representation, the bus in the accompanying drawings is not limited to only one bus or one type of bus.

The above-mentioned storage medium can be implemented by any type of volatile or non-volatile storage device or their combination, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, disk, or optical disc. The storage medium can be any available medium that can be accessed by general-purpose or dedicated computers.

An exemplary storage medium is coupled to the processor, enabling the processor to read information from and write information to the storage medium. The storage medium can also be part of the processor. The processor and the storage medium can be located in an Application Specific Integrated Circuit (ASIC). Of course, the processor and the storage medium can also exist as discrete components in electronic devices.

Finally, the aforementioned embodiments are only used to illustrate the technical solutions of the present application, rather than to limit them. Although detailed explanations have been provided with reference to the aforementioned embodiments, those skilled in the art should understand that modifications can still be made to the technical solutions described in the aforementioned embodiments, or some or all of the technical features can be equivalently replaced. These modifications or replacements do not depart from the scope of the technical solutions of the various embodiments of the present application.

What is claimed is:

1. A method for acquiring human body measurement data applicable to a terminal device, wherein the terminal device's imaging interface displays a real-time image, the method comprising:
obtaining key point data of a target individual from the real-time image;
determining whether to send a prompt message based on an analysis of the key point data of the target individual to prompt the target individual to adjust its standing position and/or posture;
acquiring a full-body image of the target individual whose standing position and posture satisfy a preset criteria; and
determining the human body measurement data of the target individual based on the key point data in the full-body image, wherein the human body measurement data is used to indicate measurements of various body parts of the target individual.

2. The method according to claim 1, wherein the obtaining the key point data of the target individual from the real-time image comprises:
acquiring the key point data of the target individual from the real-time image based on a lightweight human body key point detection model, wherein the key point data comprises positional data of all key points of the target individual.

3. The method according to claim 1, wherein the determining whether to send the prompt message based on the analysis of the key point data of the target individual comprises:
obtaining a number of key points based on the key point data of the target individual;
if the number of key points is less than a preset threshold, determining to send a first prompt message, which prompts the target individual to stand in a designated area of the imaging interface.

4. The method according to claim 1, wherein the determining whether to send the prompt message based on the analysis of the key point data of the target individual comprises:
determining a detection frame corresponding to the target individual based on the key point data;
obtaining a ratio of an area of the detection frame to an area of the real-time image;
if the ratio is less than a preset ratio threshold, determining to send a second prompt message, which prompts the target individual to move to a designated area of the imaging interface.

5. The method according to claim 1, wherein the determining whether to send the prompt message based on the analysis of the key point data of the target individual comprises:
determining posture data of the target individual based on the key point data;
if the posture data is out of a preset range for the posture data, determining to send a third prompt message, which prompts the target individual to adjust its standing posture.

6. The method according to claim 5, wherein the posture data comprises at least one of the following:
an openness degree of upper limbs, determined based on positional data of upper limb key points of the target individual;
a shoulder offset degree, determined based on positional data of left and right shoulder key points of the target individual;
a trunk offset degree, determined based on positional data of limb key points and a height of the target individual;
a bending degree of lower limbs, determined based on positional data of lower limb key points and the height of the target individual;
a verticality of the upper limbs, determined based on positional data of the upper limb key points and hip key points of the target individual.

7. The method according to claim 1, the method further comprises:
if it is determined to send the prompt message, displaying the prompt message on the imaging interface of the terminal device, or broadcasting the prompt message through a speaker of the terminal device.

8. The method according to claim 1, wherein the full-body image comprises both a front full-body image and a side full-body image of the target individual; and wherein determining the human body measurement data of the target individual based on the key point data in the full-body image comprises:
acquiring first key point data from the front full-body image and second key point data from the side full-body image of the target individual;
determining the human body measurement data of the target individual based on the first and second key point data.

9. A method for processing human body measurement data applicable to a terminal device, wherein an item interface of the terminal device displays a target item currently being browsed by a target individual, the method comprising:
in response to a detection of a trigger operation on a processing control of the item interface, obtaining standard size data of the target item from the server;
if the terminal device does not contain the human body measurement data of the target individual, controlling the terminal device to enter an imaging interface, and in the imaging interface, acquiring a full-body image of the target individual whose standing position and posture meet preset requirements, the imaging interface including a prompt message, which is used to prompt the target individual to adjust its standing position and/or posture;
determining the human body measurement data of the target individual through obtaining the key point data from the full-body image of the target individual;
based on the human body measurement data of the target individual and the standard size data, determining a recommended size for the target individual.

10. The method according to claim 9, wherein if the processing control is a control for adding items to a shopping cart, the method further comprises:
after determining the recommended size, generating add-to-cart information for the target individual based on the recommended size and an identifier of the target item.

11. The method according to claim 9, wherein if the processing control is a size inquiry control, the method further comprises:
after determining the recommended size, controlling the terminal device to enter a body measurement display interface, where the body measurement data of the target individual and the recommended size of the target item are displayed.

12. An electronic device comprising:
one or more processors; and
one or more computer-readable memories coupled to the one or more processors and having instructions stored thereon that are executable by the one or more processors to perform one or more operations comprising:
obtaining key point data of a target individual from a real-time image;
determining whether to send a prompt message based on an analysis of the key point data of the target individual to prompt the target individual to adjust its standing position and/or posture;
acquiring a full-body image of the target individual whose standing position and posture satisfy a preset criteria; and
determining the human body measurement data of the target individual based on the key point data in the full-body image, wherein the human body measurement data is used to indicate measurements of various body parts of the target individual.

13. The electronic device according to claim 12, wherein the obtaining the key point data of the target individual from the real-time image comprises:
acquiring the key point data of the target individual from the real-time image based on a lightweight human body key point detection model, wherein the key point data comprises positional data of all key points of the target individual.

14. The electronic device according to claim 12, wherein the determining whether to send the prompt message based on the analysis of the key point data of the target individual comprises:
obtaining a number of key points based on the key point data of the target individual;
if the number of key points is less than a preset threshold, determining to send a first prompt message, which prompts the target individual to stand in a designated area of an imaging interface.

15. The electronic device according to claim 12, wherein the determining whether to send the prompt message based on the analysis of the key point data of the target individual comprises:
determining a detection frame corresponding to the target individual based on the key point data;
obtaining a ratio of an area of the detection frame to an area of the real-time image;
if the ratio is less than a preset ratio threshold, determining to send a second prompt message, which prompts the target individual to move to a designated area of an imaging interface.

16. The electronic device according to claim 12, wherein the determining whether to send the prompt message based on the analysis of the key point data of the target individual comprises:
determining posture data of the target individual based on the key point data;
if the posture data is out of a preset range for the posture data, determining to send a third prompt message, which prompts the target individual to adjust its standing posture.

17. The electronic device according to claim 16, wherein the posture data comprises at least one of the following:
an openness degree of upper limbs, determined based on positional data of upper limb key points of the target individual;
a shoulder offset degree, determined based on positional data of left and right shoulder key points of the target individual;
a trunk offset degree, determined based on positional data of limb key points and a height of the target individual;
a bending degree of lower limbs, determined based on positional data of lower limb key points and the height of the target individual;
a verticality of the upper limbs, determined based on positional data of the upper limb key points and hip key points of the target individual.

18. The electronic device according to claim 12, the operations further comprising:
if it is determined to send the prompt message, displaying the prompt message on an imaging interface of the electronic device, or broadcasting the prompt message through a speaker of the electronic device.

19. The electronic device according to claim 12, wherein the full-body image comprises both a front full-body image and a side full-body image of the target individual; and wherein determining the human body measurement data of the target individual based on the key point data in the full-body image comprises:
acquiring first key point data from the front full-body image and second key point data from the side full-body image of the target individual;
determining the human body measurement data of the target individual based on the first and second key point data.
